(19) United States
(12) Patent Application Publication
(10) Pub. No.: US 2012/0007781 A1
(43) Pub. Date: Jan. 12, 2012

(54) ANTENNA MODULE

(75) Inventors: Joo Yong KIM, Seongnam (KR); Dong Young KIM, Daejeon (KR); Kwang Jae OH, Suwon (KR); Yun Hwi PARK, Yongin (KR); Bong Gyun KIM, Suwon (KR); Yoon Hyuck CHOI, Yongin (KR); Seok Chool YOON, Hwaseong (KR)

(73) Assignee: SAMSUNG ELECTRO-MECHANICS CO., LTD., Gyunggi-do (KR)

(21) Appl. No.: 12/984,081

(22) Filed: Jan. 4, 2011

(30) Foreign Application Priority Data
Jul. 6, 2010 (KR) 10-2010-0064914

(51) Int. Cl. H01Q 1/38

(52) U.S. Cl. 343/700 MS

(57) ABSTRACT

There is provided an antenna module. The antenna module according to the present invention may include a patch antenna resonator formed on a surface of a dielectric substrate; and a surface wave-radiation resonator disposed to be separated from the patch antenna resonator, and formed to surround the patch antenna resonator so that signals from the patch antenna resonator are radiated. In this instance, the signals may flow on the surface of the dielectric substrate.

### CROSS-REFERENCE TO RELATED APPLICATIONS

This application claims the priority of Korean Patent Application No. 10-2010-0064914 filed on Jul. 6, 2010, in the Korean Intellectual Property Office, the disclosure of which is incorporated herein by reference.

### BACKGROUND OF THE INVENTION

1. Field of the Invention

The present invention relates to an antenna module, and more particularly, to an antenna module, which may have broadband characteristics and high radiation efficiency in a millimeter-wave band by radiating signals flowing on a surface of a dielectric substrate.

2. Description of the Related Art

Since the millimeter-wave band frequency has a short wavelength, the miniaturization of an antenna therefor may be readily realized. Also, since the frequency of the millimeter-wave band has excellent straight advancing property in comparison with a microwave band frequency and has broadband characteristics, the millimeter-wave band frequency may be used for a radar device or for broadband communication services.

In the configuration of a millimeter-wave band system, a type of System on Packaging (SOP) may be adopted for the purpose of the miniaturization of a product and cost reduction, and as a method for the SOP, Low Temperature Co-fired Ceramics (LTCC) technology or Liquid Crystal Polymer (LCP) technology may be considered. The LTCC or LCP technology may basically use a multi-layer substrate, on which passive components such as a capacitor, an inductor, a filter, and the like may be embedded, and thereby, the miniaturization and cost reduction of a module may be realized. Also, a cavity may be freely formed on the substrate, and thereby a degree of freedom of a configuration of the module may be increased.

In this manner, one of factors highly influencing a system performance in the configuration of the system using the SOP may be an embodiment of a patch antenna. However, in the case of a patch antenna that is operated in a millimeter wave-frequency band, or more particularly, in an ultra high frequency band of at least 60 GHz, signal leakage may occur in a type of a surface wave flowing on the surface of the dielectric substrate. Here, the signal leakage may be increased along with an increase in the thickness and permittivity of the substrate. The signal leakage may degrade the radiation efficiency of the antenna to thereby reduce antenna gain.

In addition, a relatively wide bandwidth of at least 7 GHz may be required in a 60 GHz band communication system; however, it may be difficult to embody an antenna having the above mentioned wide bandwidth in a configuration of the conventional patch antenna.

Accordingly, only an antenna part may be fabricated as an organic substrate having relatively low permittivity in comparison with a ceramic substrate such as the LTCC; however, this may cause a significant increase in size and in the manufacturing costs of a module in comparison with a module entirely manufactured in a type of an SOP module including the antenna formed on a single LTCC substrate.

### SUMMARY OF THE INVENTION

An aspect of the present invention provides an antenna module in which a structure of an antenna where efficiency and a gain of the antenna is enhanced and a band of the antenna is increased by suppressing an advance of a surface wave and by re-radiating surface wave type signals may be embodied on a multi-layer substrate having high permittivity such as Low Temperature Co-fired Ceramics (LTCC).

According to an aspect of the present invention, there is provided an antenna module, including: a patch antenna resonator formed on a surface of a dielectric substrate; and a surface wave-radiation resonator disposed to be separated from the patch antenna resonator, and formed to surround the patch antenna resonator so that signals flowing on the surface of the dielectric substrate from the patch antenna resonator are radiated.

The surface wave-radiation resonator may be shaped into a metal band.

The patch antenna resonator may be a circular patch, and the surface wave-radiation resonator may be shaped into a circular ring in such a manner as to surround the patch antenna resonator.

The patch antenna resonator may be a rectangular patch, and the surface wave-radiation resonator may be shaped into a rectangular ring in such a manner as to surround the patch antenna resonator.

The patch antenna resonator may include a feeding line formed in a side thereof, and the surface wave-radiation resonator may include a slot through which the feeding line passes.

The antenna module may further include: a second surface wave-radiation resonator formed to correspond to the surface wave-radiation resonator in a thickness direction of the dielectric substrate; and a via electrically connecting the surface wave-radiation resonator and the second surface wave-radiation resonator.

The surface wave-radiation resonator may have a size capable of resonating in a frequency band of the patch antenna resonator.

The surface wave-radiation resonator may have a size capable of resonating in a frequency band adjacent to a frequency band of the patch antenna resonator.

A resonance frequency of the surface wave-radiation resonator may be determined by a width and a thickness of the surface wave-radiation resonator, and a distance between the surface wave-radiation resonator and the patch antenna resonator.

A bandwidth of an antenna may be increased by performing coupling between a resonance peak of the patch antenna resonator and a resonance peak of the surface wave-radiation resonator.

The dielectric substrate may be connected to a circuit board on which a ground pattern is formed.

The patch antenna resonator and the surface wave-radiation resonator may be operable in a frequency of a millimeter-wave band.

The dielectric substrate may be formed of Low Temperature Co-fired Ceramics (LTCC) or a Liquid Crystal Polymer (LCP).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a top view showing an antenna module according to a first exemplary embodiment of the present invention;

FIG. 2 is a cross-sectional view in a thickness direction showing radiation of signals in the antenna module according to the first exemplary embodiment of the present invention;

FIGS. 3A and 3B are a graph showing reflection characteristics (S11) and radiation characteristics (antenna gain) of the antenna module according to the first exemplary embodiment of the present invention;

FIG. 4 is an exploded perspective view showing an antenna module according to a second exemplary embodiment of the present invention;

FIG. 5 is a cross-sectional view in a thickness direction showing radiation of signals in the antenna module according to the second exemplary embodiment of the present invention;

FIG. 6 is a perspective view showing an antenna module according to a third exemplary embodiment of the present invention;

FIGS. 7A and 7B are a graph showing reflection characteristics (S11) and radiation characteristics (antenna gain) of the antenna module according to the third exemplary embodiment of the present invention; and

FIGS. 8A and 8B are a graph showing reflection characteristics (S11) and radiation characteristics (antenna gain) of an antenna module according to a comparative exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, and those are to be construed as being included in the spirit of the present invention.

Further, throughout the drawings, the same or similar reference numerals will be used to designate the same components or like components having the same functions in the scope of the similar idea.

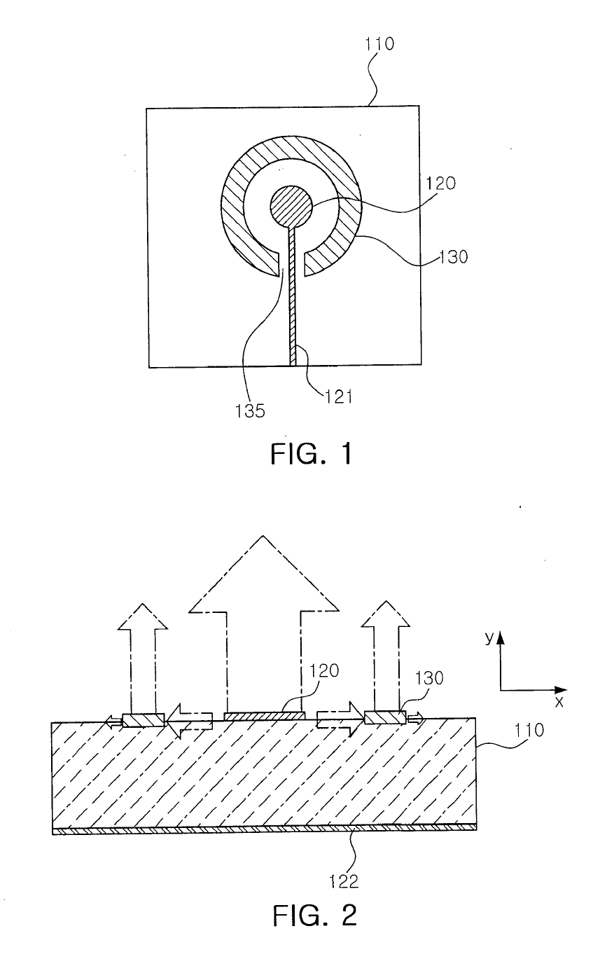

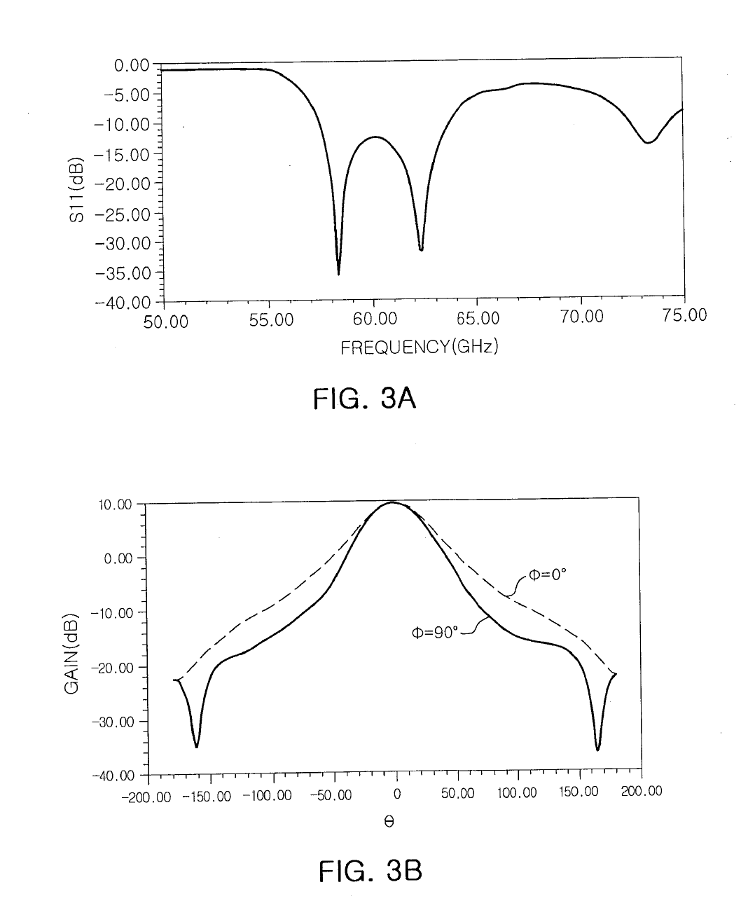

FIG. 1 is a top view showing an antenna module according to a first exemplary embodiment of the present invention, FIG. 2 is a cross-sectional view in a thickness direction showing radiation of signals in the antenna module according to the first exemplary embodiment of the present invention, and FIGS. 3A and 3B are a graph showing reflection characteristics (S11) and radiation characteristics (antenna gain) of the antenna module according to the first exemplary embodiment of the present invention.

Referring to FIGS. 1 to 3B, the antenna module according to the first exemplary embodiment of the present invention may include a patch antenna resonator 120 and a surface wave radiation resonator 130 which are formed on a dielectric substrate 110.

The dielectric substrate 110 may be embodied as a semiconductor substrate such as silicon (Si), a ceramic substrate such as a Low Temperature Co-fired Ceramics (LTCC) for a high frequency, or an organic substrate such as a Liquid Crystal Polymer (LCP).

According to the present exemplary embodiment, the dielectric substrate 110 may be designed as a substrate formed such that six layer-LTCC substrates in which a single layer has a thickness of 0.06 mm are stacked to one another to thereby have an entire thickness of 0.36 mm. Here, the substrate has permittivity of 9.2 and a dielectric loss of 0.002.

The patch antenna resonator 120 may be formed on the surface of the dielectric substrate 110 in a type of a circular patch, and a feeding line 121 may be connected to a side of the circular patch. A ground 122 may be formed on a rear surface of the dielectric substrate 110.

The surface wave-radiation resonator 130 may be formed on the dielectric substrate 110 to surround the patch antenna resonator 120 while being spaced apart from the patch antenna resonator 120 by a predetermined distance, so that signals leaked from the patch antenna resonator 120 is radiated.

The surface wave-radiation resonator 130 may be shaped into a metal band, and include a slot 135 through which the feeding line 121 formed in a side of the patch antenna resonator 120 passes.

Since the surface wave-radiation resonator 130 is formed to surround the patch antenna resonator 120, the surface wave-radiation resonator 130 may be shaped to conform to a circumference of the patch antenna resonator 120. That is, since the patch antenna resonator 120 is formed of the circular patch, the surface wave-radiation resonator 130 may be shaped into a circular ring having the same center as that of the patch antenna resonator 120.

A size of the surface wave-radiation resonator 130 may be determined in such a manner that signals flowing on the surface of the dielectric substrate 110 from the patch antenna resonator 120 are radiated. For example, the surface wave-radiation resonator 130 may be designed to have a size capable of resonating in a frequency band adjacent to a frequency band of the patch antenna resonator 120, or may be designed to have a size capable of resonating in the frequency band of the patch antenna resonator 120.

In this instance, when appropriately performing coupling between a peak of the surface wave-radiation resonator 130 and a peak of the patch antenna resonator 120 by adjusting a width and a thickness of the surface wave-radiation resonator 130, a distance between the surface wave-radiation resonator 130 and the patch antenna resonator 120, and a width of the slot 135, a bandwidth of an antenna may be increased. The thickness of the surface wave-radiation resonator 130 may be preferably formed to be practically the same as or greater than that of the patch antenna resonator 120 so that a surface wave signal of the patch antenna resonator 120 is blocked and radiated.

According to the present exemplary embodiment, the patch antenna resonator 120 may be designed to have a diameter of 0.67 mm, and the surface wave radiation resonator 130 may be designed to have a width of 0.59 mm, a thickness of 10 μm, and an outer diameter of 1.45 mm. Also, the slot 135 may be designed to have a width of 0.3 mm, and the feeding line 121 may be designed to have a width of 0.08 mm. Here, FIGS. 3A and 3B may be obtained by measuring antenna characteristics according to the present exemplary embodiment by an electromagnetic field simulation using a High Frequency Simulation Software (HFSS).

As shown in FIG. 3A, the antenna module according to the present exemplary embodiment may have a bandwidth of 6.2 GHz ranging from 57.5 GHz to 63.7 GHz, and two poles by a dual resonator may exist. That is, a resonance peak of each of the patch antenna resonator 120 and the surface wave-radiation resonator 130 surrounding the patch antenna resonator 120 may exist, and the bandwidth of the antenna module may be adjusted by adjusting a degree of coupling between the two resonance peaks.

Also, as shown in FIG. 3B, antenna gain of the antenna module according to the present exemplary embodiment may be 9.6 dBi, and a gain in a direction (Φ=90°) perpendicular to the feeding line 121 and a gain in a direction (Φ=0°) horizontal to the feeding line 121 may be almost similar to each other. In this instance, radiation efficiency of the antenna module may be 60.8%.

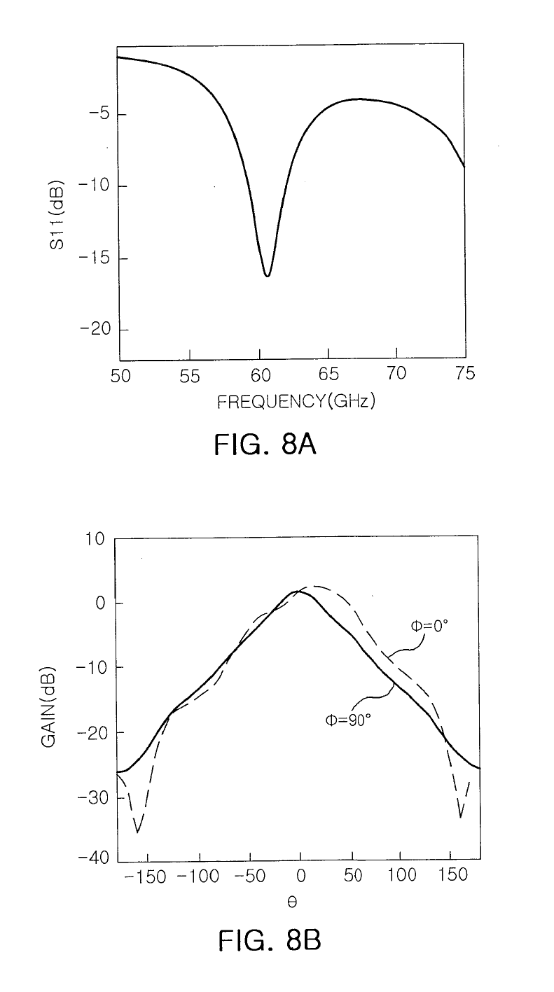

FIGS. 8A and 8B are a graph showing reflection characteristics (S11) and radiation characteristics (antenna gain) of an antenna module according to a comparative exemplary embodiment of the present invention. The antenna module according to the comparative exemplary embodiment may be a patch antenna embodied on a general dielectric substrate, and may use a dielectric substrate which has permittivity of 9.2 and a dielectric loss of 0.002 and is formed such that six layer-LTCC substrates in which a thickness of a single layer is 0.06 mm are stacked to one another to thereby have an entire thickness of 0.36 mm.

As shown in FIG. 8A, a frequency band of the antenna module according to the comparative exemplary embodiment may have a bandwidth of 2.7 GHz ranging from 59.3 GHz to 62 GHz. As shown in FIG. 8B, antenna gain may be 2.5 dBi, and radiation efficiency of the antenna may be 25%.

Accordingly, it may be found that the antenna module according to the first exemplary embodiment of the present invention may have about three times wider bandwidth, about four times higher antenna gain, and about 2.5 times greater radiation efficiency of an antenna in comparison with the antenna module according to the comparative exemplary embodiment.

This is because in the antenna module according to the present exemplary embodiment, as shown in FIG. 2, signals (see an arrow in an x-axis direction) flowing on the surface of the dielectric substrate 110 from the patch antenna resonator 120 and then leaked is re-radiated (see an arrow in a y-axis direction) in the surface wave-radiation resonator 130.

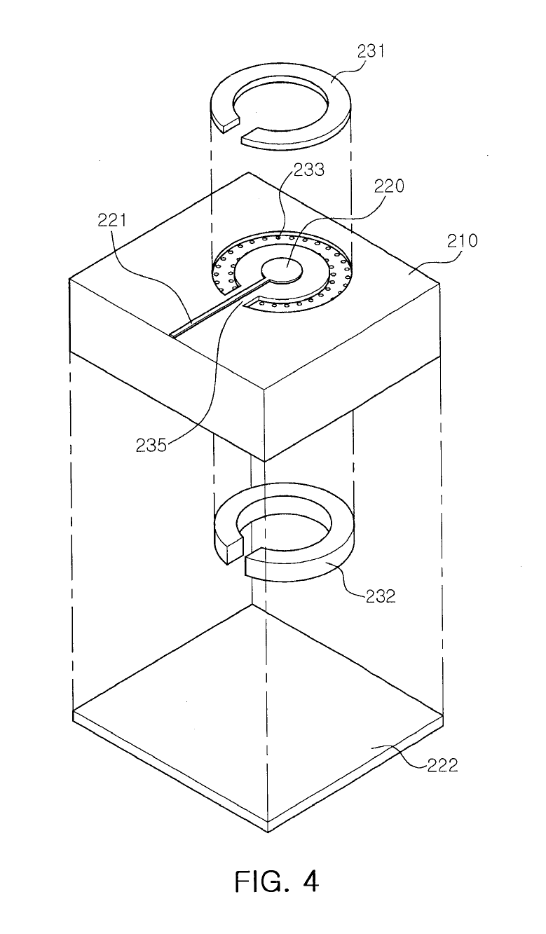

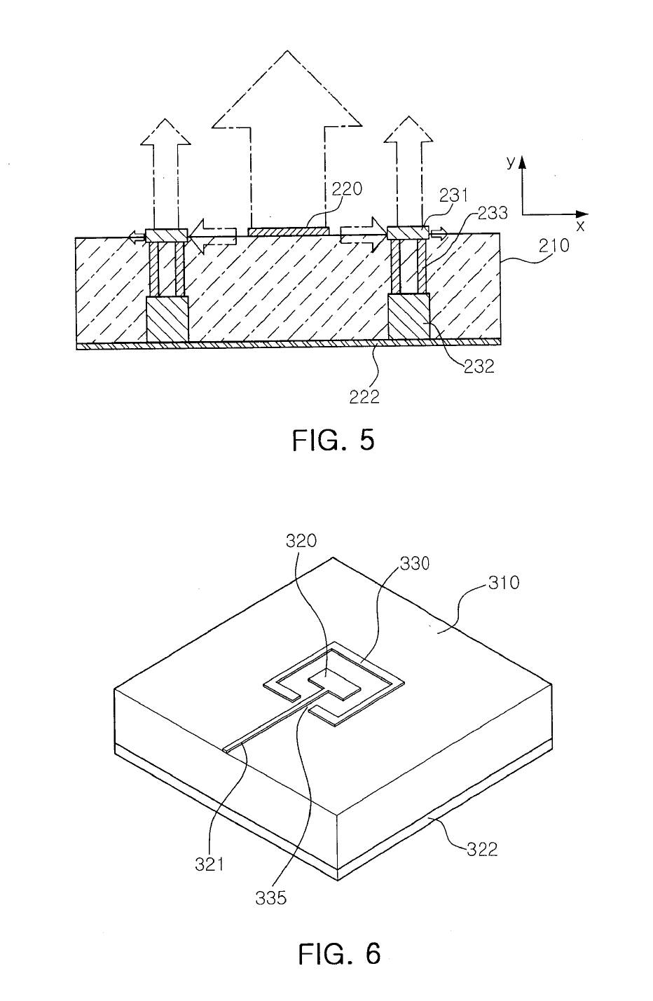

FIG. 4 is an exploded perspective view showing an antenna module according to a second exemplary embodiment of the present invention, and FIG. 5 is a cross-sectional view in a thickness direction showing radiation of signals in the antenna module according to the second exemplary embodiment of the present invention.

As for the antenna module according to the second exemplary embodiment of the present invention shown in FIGS. 4 and 5, the surface wave-radiation resonator may be formed inside the dielectric substrate as well as being formed on the surface of the dielectric substrate, and other configurations of the antenna module according to the second exempt may be the same as those of the antenna module according to the first exemplary embodiment shown in FIG. 1. Thus, detailed descriptions thereof will be omitted, and further descriptions will hereinafter be made focusing on differences therebetween.

Referring to FIGS. 4 and 5, the antenna module according to the second exemplary embodiment of the present invention may include a patch antenna resonator 220 formed on a dielectric substrate 210, a feeding line 221 formed in a side of the patch antenna resonator 220, and a ground 222 formed on a rear surface of the dielectric substrate 210.

Meanwhile, a first surface wave-radiation resonator 231 shaped into a circular ring may be formed on the dielectric substrate 210 to surround the patch antenna resonator 220 while being spaced apart from the patch antenna resonator 220 by a predetermined distance, and a second surface wave-radiation resonator 232 shaped into a circular ring may be formed inside the dielectric substrate 210 in a thickness direction of the dielectric substrate 210 to correspond to the first surface wave-radiation resonator 231.

In this instance, the first surface wave-radiation resonator 231 and the second surface wave-radiation resonator 232 may be connected to each other by vias 233 formed in the thickness direction of the dielectric substrate 210. The vias 233 may be arranged along circumferences of the first and second surface wave-radiation resonators.

The first surface wave-radiation resonator 231 and the second surface wave-radiation resonator 232 may be designed to have the same size, and may be designed to have different sizes depending on a desired frequency band and bandwidth. That is, according to the present exemplary embodiment, a thickness of the second surface wave-radiation resonator 232 may be designed to be greater than that of the first surface wave-radiation resonator 231.

Characteristics of the antenna module according to the present exemplary embodiment may be as follows:

TABLE 1

| Surface | | | Antenna | Antenna |
|---|---|---|---|---|
| wave-radiation | Thickness | Bandwidth | gain | efficiency |
| resonator | (μm) | (GHz) | (dBi) | (%) |
| First surface | 70 | 57.7~63.1 | 9.4 | 67 |
| wave-radiation | | (5.4) | | |
| resonator | | | | |
| Second surface | 130 | 58.2~63.6 | 9.4 | 65 |
| wave-radiation | | (5.4) | | |
| resonator | | | | |

As shown in Table 1, it may be found that almost the same antenna characteristics may be shown even though a thickness of the first surface-radiation resonator 231 is half smaller than a thickness of the second surface wave-radiation resonator 232.

The second surface wave-radiation resonator 232 may be formed in an inner layer of the dielectric substrate 210, or may be embedded in a cavity formed in a rear surface of the dielectric substrate 210 as shown in FIG. 5.

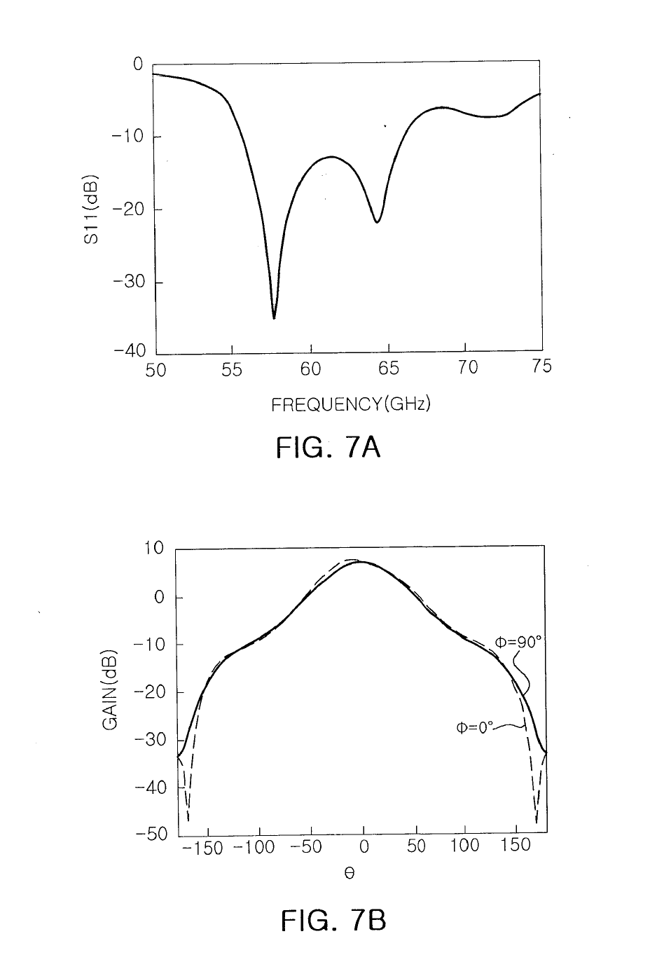

FIG. 6 is a perspective view showing an antenna module according to a third exemplary embodiment of the present invention, and FIGS. 7A and 7B are a graph showing reflection characteristics (S11) and radiation characteristics (antenna gain) of the antenna module according to the third exemplary embodiment of the present invention.

As for the antenna module according to the third exemplary embodiment of the present invention shown in FIGS. 6 to 7B, the patch antenna resonator may be formed of a rectangular patch, and the surface wave-radiation resonator may be shaped into a rectangular ring. Here, other configurations of the antenna module according to the third exemplary embodiment may be the same as those of the antenna module according to the first exemplary embodiment shown in FIG. 1. Thus, detailed descriptions thereof will be omitted, and further descriptions will hereinafter be made focusing on differences therebetween.

Referring to FIG. 6, the antenna module according to the third exemplary embodiment may include a patch antenna resonator 320 and a surface wave-radiation resonator 330 which are formed on a dielectric substrate 310.

The patch antenna resonator 320 may be formed of a rectangular patch, and include a feeding line 321 in a side thereof. Also, the patch antenna resonator 320 may be connected to a ground 322 formed on a lower surface of the dielectric substrate 310.

The surface wave-radiation resonator 330 may be formed on the dielectric substrate 310 to surround the patch antenna resonator 320 while being spaced apart from the patch antenna resonator 320 by a predetermined distance, so that signals leaked from the patch antenna resonator 320 are radiated.

The surface wave-radiation resonator 330 may be shaped into a metal band, and include a slot 335 through which the feeding line 321 formed in the side of the patch antenna resonator 320 passes.

Since the surface wave-radiation resonator 330 is formed to surround the patch antenna resonator 320, the surface wave-radiation resonator 330 may be shaped to conform to edges of the patch antenna resonator 320. That is, since the patch antenna resonator 320 according to the present exemplary embodiment is formed of the rectangular patch, the surface wave-radiation resonator 330 may be shaped into a rectangular ring.

FIGS. 7A and 7B may be obtained by measuring characteristics of the antenna module according to the present exemplary embodiment by an electromagnetic field simulation using an HFSS.

As shown in FIG. 7A, the antenna module according to the present exemplary embodiment may have a bandwidth of 10.2 GHz ranging from 55.8 GHz to 66 GHz. As shown in FIG. 7B, the antenna module according to the present exemplary embodiment may have antenna gain of 7.1 dBi, and a gain in a direction (Φ=90°) perpendicular to the feeding line 321 and a gain in a direction (Φ=0°) horizontal to the feeding line 321 may be almost similar to each other.

Accordingly, it may be found that the antenna module according to the present exemplary embodiment may exhibit significantly enhanced characteristics in comparison with characteristics of the antenna module according to the comparative exemplary embodiment shown in FIGS. 8A and 8B.

As set forth above, according to exemplary embodiments of the present invention, there is provided the antenna module, which may dispose the surface wave-radiation resonator to surround the patch antenna resonator to thereby prevent surface-wave type signals from being leaked into the dielectric substrate, and may re-radiate signals flowing from the patch antenna resonator to the surface wave-radiation resonator to thereby enhance radiation efficiency and antenna gain.

In addition, there is provided the antenna module, which may adjust coupling between the patch antenna resonator and the surface wave-radiation resonator to thereby increase a bandwidth of the antenna.

As described above, the exemplary embodiments of the present invention have been described in detail; however, these are merely an example, and various changes can be made by those skilled in the art within the spirit and scope of the invention. For example, according to the present invention, characteristics such as the permittivity and the dielectric loss of the dielectric substrate and a thickness or a number of stacked substrates may be changed in various manners in accordance with required design conditions. Also, a dimension and type of each of the patch antenna resonator and the surface wave-radiation resonator, and a disposed type of the surface wave-radiation resonator may be changed in various manners in accordance with required design conditions. For example, according to the second exemplary embodiment of the present invention, the surface wave-radiation resonator may be formed of two-layers; however, this is merely an example, and the surface wave-radiation resonator may be formed of at least three layers.

While the present invention has been shown and described in connection with the exemplary embodiments, it will be apparent to those skilled in the art that modifications and variations can be made without departing from the spirit and scope of the invention as defined by the appended claims.

What is claimed is:

1. An antenna module, comprising:
a patch antenna resonator formed on a surface of a dielectric substrate; and
a surface wave-radiation resonator disposed to be separated from the patch antenna resonator, and formed to surround the patch antenna resonator so that signals flowing on the surface of the dielectric substrate from the patch antenna resonator are radiated.

2. The antenna module of claim 1, wherein the surface wave-radiation resonator is shaped into a metal band.

3. The antenna module of claim 1, wherein the patch antenna resonator is a circular patch, and the surface wave-radiation resonator is shaped into a circular ring in such a manner as to surround the patch antenna resonator.

4. The antenna module of claim 1, wherein the patch antenna resonator is a rectangular patch, and the surface wave-radiation resonator is shaped into a rectangular ring in such a manner as to surround the patch antenna resonator.

5. The antenna module of claim 1, wherein the patch antenna resonator includes a feeding line formed in a side thereof, and the surface wave-radiation resonator includes a slot through which the feeding line passes.

6. The antenna module of claim 1, further comprising:
a second surface wave-radiation resonator formed to correspond to the surface wave-radiation resonator in a thickness direction of the dielectric substrate; and
a via electrically connecting the surface wave-radiation resonator and the second surface wave-radiation resonator.

7. The antenna module of claim 1, wherein the surface wave-radiation resonator has a size capable of resonating in a frequency band of the patch antenna resonator.

8. The antenna module of claim 1, wherein the surface wave-radiation resonator has a size capable of resonating in a frequency band adjacent to a frequency band of the patch antenna resonator.

9. The antenna module of claim 1, wherein a resonance frequency of the surface wave-radiation resonator is determined by a width and a thickness of the surface wave-radiation resonator, and a distance between the surface wave-radiation resonator and the patch antenna resonator.

10. The antenna module of claim 1, wherein a bandwidth of an antenna is increased by performing coupling between a resonance peak of the patch antenna resonator and a resonance peak of the surface wave-radiation resonator.

11. The antenna module of claim 1, wherein the dielectric substrate is connected to a circuit board on which a ground pattern is formed.

12. The antenna module of claim 1, wherein the patch antenna resonator and the surface wave-radiation resonator are operable in a frequency of a millimeter-wave band.

13. The antenna module of claim 1, wherein the dielectric substrate is formed of Low Temperature Co-fired Ceramics (LTCC) or a Liquid Crystal Polymer (LCP).
